(19) United States
(12) Patent Application Publication
(10) Pub. No.: US 2015/0186860 A1
(43) Pub. Date: Jul. 2, 2015

(54) FRAMEWORK THAT FACILITATES ACCESSING DIGITAL ITEMS

(71) Applicant: Microsoft Corporation, Redmond, WA (US)

(72) Inventor: Nikhil Devanur Rangarajan, Redmond, WA (US)

(73) Assignee: Microsoft Corporation, Redmond, WA (US)

(21) Appl. No.: 14/146,030

(22) Filed: Jan. 2, 2014

(51) Int. Cl. G06Q 20/14; G06Q 20/24

(52) U.S. Cl. CPC G06Q 20/145; G06Q 20/24

(57) ABSTRACT

A framework that facilitates the sale of digital items is described herein. The framework is configured to charge an account of a consumer an access price for each access to a digital item, until an aggregate of access prices charged (to the account) for the digital item reaches a threshold. Once the aggregate of access prices charge (to the account) for the digital item reaches the threshold, the account is not charged for subsequent accesses to the digital item. Thus, the consumer has purchased the digital item.

### BACKGROUND

There are numerous frameworks in place for selling digital items to consumers, where digital items can include music files (e.g., individual songs, albums, etc.), video files (e.g., television shows, movies, podcasts, etc.), video games (e.g., playable on computing devices, such as mobile computing devices, conventional computing devices, video game consoles, etc.), computer-executable applications (e.g., productivity applications, such as word processing applications, spreadsheet applications, etc.), amongst others. A conventional approach for selling a digital item includes encoding the digital item on a computer-readable storage medium (such as a disk) and then selling the computer-readable storage medium to a consumer. For instance, the consumer can travel to a brick and mortar store and purchase a disk that has a desirably purchased digital item encoded thereon, such as a song, a movie, a video game, an application, etc.

Another exemplary conventional approach for selling a digital item includes providing an online marketplace, where the online marketplace includes an interface that allows a consumer to select, purchase, and download a digital item. For example, online music marketplaces exist that allow the consumer to identify a song that is desirably purchased, purchase such song by credit card or other payment form, and download the purchased song to a client computing device of the consumer, where the consumer can cause the song to be played when desired. In another exemplary approach, a digital item purchased by way of the online marketplace can be retained on a server operated by an operator of the online marketplace. The server streams the digital item to a client computing device of the consumer responsive to authenticating identification data (username and password) provided by the consumer. Further, in the case of computer-executable applications, when the consumer purchases an application, at least a portion of the application may be executed at on the server and streamed to the client computing device.

Relatively recently, subscription-based frameworks have become popular to allow for consumers to access digital items. In a subscription-based framework, the consumer pays a recurring fee (e.g., monthly or annually) to obtain access to at least one digital item. For example, a subscription-based music service allows the consumer to select and play songs at the convenience of the consumer, so long as the consumer has paid the subscription fee. With respect to an exemplary subscription-based service, the consumer is able to download, stream, play, use, etc. a digital item from a library made available by the subscription-based service. When the subscription fee is not paid by the consumer, access to the digital item(s) is disabled.

### SUMMARY

The following is a brief summary of subject matter that is described in greater detail herein. This summary is not intended to be limiting as to the scope of the claims.

Described herein are various technologies pertaining to a framework that facilitates sale of a digital item based upon incremental access fees charged to an account of a consumer that access the digital item. In an example, a consumer can employ a client computing device to access a server computing device by way of a network, wherein the server computing device comprises at least one digital item that is available for purchase. In an example, the at least one digital item may be a media file (e.g., music file, a video file, a digital book, a digital magazine, etc.), a video game, a computer-executable productivity application, or other suitable digital item. To that end, the client computing device may have a display screen, and a graphical user interface (GUI) can be presented thereon responsive to the client computing device accessing the server computing device. The GUI includes a graphical item that is representative of the at least one digital item that is purchaseable by the consumer.

In contrast to conventional frameworks, which require the consumer to pay a full purchase price or full subscription price prior to allowing the consumer to access the digital item, the framework described herein facilitates selling the digital item to the consumer based upon accesses to the digital item made by the consumer. Accordingly, the server computing device can be configured to track accesses to the digital item made by the consumer (potentially across multiple client computing devices of the consumer), and charging an account of the consumer based upon the accesses. When the aggregate charge to the account for the digital item reaches a threshold (purchase price), the consumer has purchased the digital item and can thereafter access the digital item for no additional charge.

In an example, the digital item may be a music file (song) that is desirably played by the consumer at a client computing device of the consumer (e.g., mobile telephone). Conventional approaches for selling a song to the consumer require the consumer to pay a full purchase price up front. Other conventional approaches require the consumer to have a fully-paid subscription prior to allowing the consumer to play the song at the client computing device. In contrast, the framework described herein is configured to charge an access price to an account of the consumer each time the consumer plays the song, until the aggregate of access prices charged to the account of the consumer reaches a predefined purchase price. When the predefined purchase price for the song has been charged to the account of the consumer, the consumer has purchased a license to play the song whenever she likes without her account being charged for further accesses. Therefore, for example, rather than charging the full purchase price of the song (e.g., one dollar) to the account of the consumer prior to allowing the consumer to play the song, the framework described herein is configured to charge the account of the consumer an access price (e.g., ten cents) each time that the consumer plays the song until the aggregate of charged access prices reaches the purchase price. Using the example figures set forth above, the account of the consumer is charged ten cents for each play of the song for the first ten plays of the song; for the eleventh and subsequent plays, the account of the consumer is not charged (as the consumer has purchased the song).

It can be ascertained that certain types of digital items are not readily correlated to the monitoring of individual accesses. For example, a consumer may access a video game a single time, but may play the video game for several hours. With respect to these types of digital items, the access price charged to the account of the consumer can be a function of an amount of time that the digital item is accessed. Pursuant to an example, the digital item may be a video game, and the consumer can begin playing the video game. The access price can correspond to a time unit, such that the account of the consumer is charged the access price for time units that the consumer plays the video game. For instance, the account of the consumer can be charged ten cents for each minute that the consumer plays the video game at a client computing device. The aggregate amount of time (over multiple accesses and potentially across multiple client computing devices) that the consumer plays the video game is tracked, and the account of the consumer is charged for each time unit that the consumer plays the video game. When the aggregate of the access prices charged to the account of the consumer for the video game reaches a predefined purchase price, the account of the consumer is not further charged when the consumer plays the video game. That is, the consumer has purchased the video game. The framework described herein for selling digital items in this manner may also be particularly well-suited for television shows and movies, thereby allowing the consumer to watch a movie or television program for a few minutes, and if the consumer dislikes the movie or television program, the consumer has only paid the access price, rather than the full purchase price.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates an exemplary framework that facilitates selling a digital item to a consumer, wherein the consumer may utilize multiple client computing devices to access the digital file.

FIG. 2 illustrates exemplary graphical user interface (GUI) features that correspond to a framework that facilitates selling a digital item to a consumer.

FIG. 3 is a functional block diagram of an exemplary server that facilitates managing a budget for the purchase of digital items, wherein digital items are purchased by way of the framework described herein.

FIG. 4 illustrates exemplary GUI features of a budget report that can assist a consumer in budgeting for the purchase of digital items by way of the framework described herein.

FIG. 5 is a functional block diagram of an exemplary client computing device that facilitates selling digital items to a consumer by way of the framework described herein.

FIG. 6 illustrates exemplary GUI features of a computer-executable application that is purchaseable by a consumer by way of the framework described herein.

FIG. 7 is a flow diagram illustrating an exemplary methodology for selling a digital item to a consumer based upon an aggregate of access prices charged to an account of the consumer for the digital item.

FIG. 8 is a flow diagram that illustrates an exemplary methodology for assisting a consumer with maintaining a budget for the purchase of digital items.

FIG. 9 is an exemplary computing system.

### DETAILED DESCRIPTION

Various technologies pertaining to a framework that facilitates selling digital items to consumers are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by a single system component may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

Described herein are various technologies pertaining to selling digital items to consumers. The term “digital item” is intended to encompass a music file (e.g., a song, an album, etc.), a music channel that is configured to stream a selected genre or genres of music to a client computing device, a video file (e.g., a television program, a movie, etc.), a digital book, a digital magazine, a digital article, a video game, a computer-executable productivity application (such as a word processing application, a spreadsheet application, etc.), amongst others. A framework is described herein, wherein the framework is configured to track accesses to digital items of numerous consumers over various client computing devices (e.g., each consumer may have multiple client computing devices). The framework is configured to sell a digital item to a consumer by charging an access price to an account of the consumer for each access to the digital item made by the consumer, and computing an aggregate of the access prices charged for the digital item. When the aggregate of access prices reaches a predefined purchase price, the framework is configured to allow access to the digital item without further charging the account of the consumer. Accordingly, it can be ascertained that the access price is less than the purchase price for the digital item. Thus, the consumer is benefited, as the consumer can “test” the digital item for a relatively nominal fee, without having to commit to a subscription service or pay a full purchase price up front for the digital item. The seller of the digital item may also be benefited, as the consumer may refrain from leaving a negative review for the digital item if the amount charged to the account of the consumer is relatively nominal. Moreover, a service for selling many different digital items may benefit from the framework described herein, as consumers may be more likely to sample digital items and may purchase digital items that they may otherwise not have purchased without the ability to “test” the digital item for the relatively nominal fee.

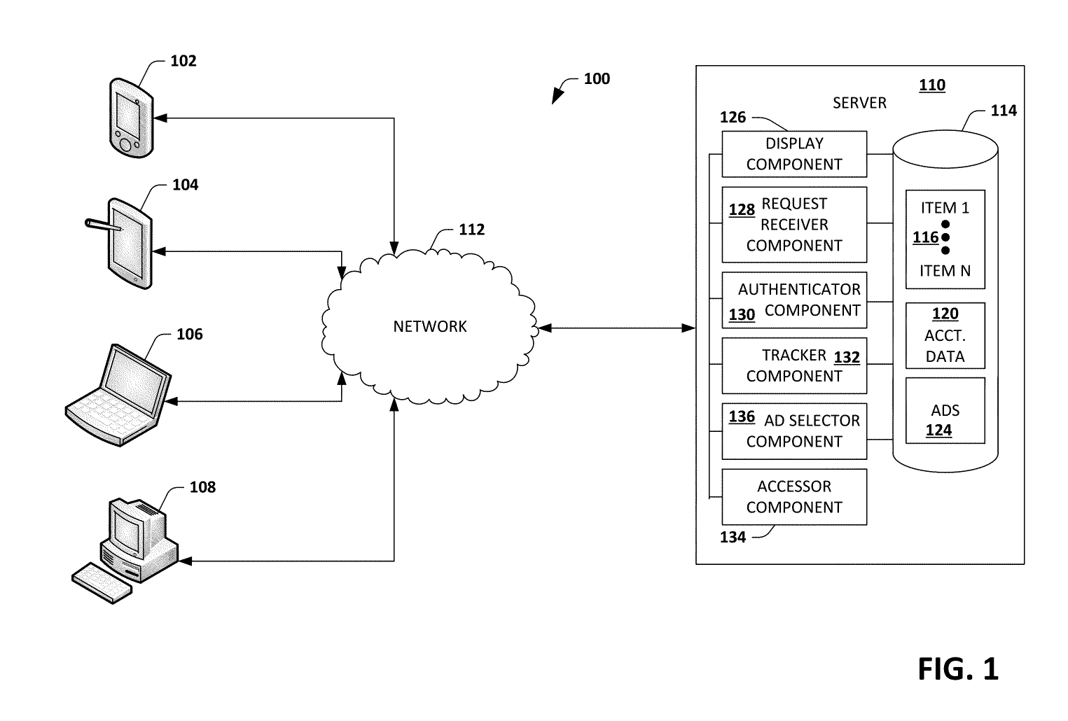

Now referring to FIG. 1, a framework 100 that facilitates selling digital items to consumers is illustrated. The framework 100 is shown as including a plurality of client computing devices 102-108 that can be employed by a consumer to access a purchasable digital item. As shown, the client computing devices 102-108 can include a mobile telephone 102, a tablet (slate) computing device 104, a laptop computing device 106, a desktop computing device 108. While not shown, the plurality of computing devices 102-108 may additionally include a set top box (e.g., a media streaming device), a television, a video game console, a wearable computing device (e.g., a watch), etc.

The framework 100 further includes a server 110 that can be accessed by the client computing devices 102-108 by way of a network 112, such as the Internet. While the server 110 is shown and described as being a single computing device, it is to be understood that functionality described herein as being performed by the server 110 may be performed by multiple servers (e.g., an authentication server, an advertisement server, etc.).

A consumer uses one of the client computing devices 102-108 to access the server 110 by way of the network 112. For example, the mobile telephone 102 may have an application installed thereon that, when executed at the mobile telephone 102, accesses the server 110. In another example, the consumer can cause, at any given time, the mobile telephone 102 (or other client computing device) to execute a browser and can direct the browser to an IP address assigned to the server 110.

The server 110 is configured to facilitate sale of at least one digital item to the consumer. To that end, the server 110 includes a data store 114 that comprises a plurality of digital items that are respectively purchaseable. Accordingly, a digital item in the plurality of digital items 116 has a respective purchase price assigned thereto, wherein the purchase price may be defined by an operator of the server 110 or by a creator or owner of the digital item. For instance, the plurality of digital items 116 can include a plurality of music files, where each music file has a respective owner (e.g. copyright holder). An owner of a music file can assign a purchase price thereto based upon market considerations, such as popularity of the artist, popularity of the song, etc. Furthermore, a digital item in the plurality of digital items 116 can have a respective access price assigned thereto, wherein the respective access price is less than the respective purchase price for the digital item. Continuing with the example of the digital items being music files, the purchase price for a first music file may be $1.00, while the access price for the music file may be $0.10 (or some unit of value, such as account points, equivalent thereto). Depending upon the type of the digital item, the access price may be 1) chargeable to the consumer for each access of the digital item by the consumer; or 2) chargeable for each predefined unit of time that the digital item is accessed by the consumer (e.g., across the client computing devices 102-108 of the consumer). When the digital items 116 are music files, the access price for a music file can be charged to an account of the consumer for each play of the music file. In contrast, when the digital items 116 are respective videogames or productivity applications, the access price can be charged to the account of the consumer for each predefined time unit (e.g., every five minutes) that a video game is played by the consumer or an application is used by the consumer.

The data store 114 may also include account data 120. The account data 120 can include information pertaining to accounts of numerous respective consumers. Each account represented in the account data 120 thus, is an account for a respective consumer, and can comprise units of value (e.g., points or money) that may be spent by the respective consumer for purchasing digital items in the plurality of digital items 116. In another exemplary embodiment, the account for the respective consumer may be linked to a credit card, checking account, etc.

The server 110 may further comprise ads 124 that can be presented to the consumer on the client computing device being employed by the consumer to access the server 110. When the consumer is willing to be presented with advertisements when accessing a digital item, the access price for accessing the digital item and/or the purchase price for purchasing the digital item may be decreased. That is, the access price and/or the purchase price for the digital item in the plurality of digital items 116 may be a first price when the digital item is not ad-supported, and a second (lower) price when the digital item is ad-supported. For instance, for at least one digital item in the plurality of digital items 116, access to the at least one digital item by the consumer may be free of charge when the consumer is willing to be presented with advertisements in connection with accessing the digital item.

As will be described in greater detail below, the server 110 can be configured to monitor accesses to digital items in the plurality of digital items 116 over multiple of the computing devices 102-108 of the consumer over time, charge appropriate access prices to the account of the consumer for accessing digital items in the plurality of digital items 116 using varying of the computing devices 102-108, and ascertain when, for a given digital item, an account of the consumer has been charged (in the aggregate) the purchase price of the digital item. When the account has been charged the purchase price for the digital item, the access price for the digital item is no longer charged to the account of the consumer when the consumer employs a client computing device to access the digital item.

With more specificity pertaining to the features described above, the server 110 can include a display component 126 that receives an indication that a client computing device (e.g., the tablet computing device 104) in the plurality of client computing devices 102-108 has communicated with the server 110. For instance, the display component 126 can receive an indication that a web browser executing on the tablet computing device 104 has been directed towards an IP address of the server 110. In another example, an application executing on the tablet computing device 104 can cause the tablet computing device 104 to transmit a signal that indicates that the application is requesting access to the server 110. Responsive to receiving such indication, the display component 126 can generate display data that is transmitted to the tablet computing device 104. Such display data can include an available balance in an account of the consumer that is using the tablet computing device 104, a list of digital items that can be purchased by the consumer, purchase prices of such digital items, an amount already paid by the consumer for one or more digital items, etc.

The consumer may interact with the display data presented on the client computing device to select at least one digital item in the plurality of digital items 116 that is desirably accessed. For example, the consumer, through employment of a gesture (a touch), can indicate that a digital item represented on the display of the tablet computing device 104 is desirably accessed. In another example, the consumer can set forth a voice command, utilize an input mechanism (such as a mouse, a stylus, etc.), or the like to indicate a desire to access the digital item from the plurality of digital items 116. The server 110 includes a request receiver component 128 that receives the request from the client computing device to access the digital item. As noted above, the digital item selected by the consumer is purchasable for a purchase price and accessible for an access price, wherein the access price is less than the purchase price. The server 110 can further comprise an authenticator component 130 that can receive identification data (e.g., username and password) from the client computing device and can identify the consumer based upon the identification data. Responsive to identifying the consumer, the authenticator component 130 can identify an account of the consumer in the account data 120.

The server 110 further includes a tracker component 132 that, responsive to the request receiver component 128 receiving the request to access the digital item in the plurality of digital items 116, performs a plurality of actions. More specifically, the tracker component 132 accesses the account data 120 and analyzes the account of the consumer to determine a total payment amount, where the total payment amount is an aggregate of access prices previously charged to the account of the consumer for the digital item. It can be ascertained that the consumer can access the digital item from any client computing device in the plurality of client computing devices 102-108; thus, the tracker component 132 can track accesses to the digital item across the computing devices 102-108. When the tracker component 132 determines that the total payment amount for the digital item is less than the purchase price of the digital item, the tracker component 132 charges the access price of the digital item to the account of the consumer. For instance, the tracker component 132 can debit the access price from units of value held in the account of the consumer. In another example, the tracker component 132 can charge the access price to a credit card linked to the account of the consumer. The tracker component 132 can then update the account of the consumer to reflect that the account has been charged the access price of the digital item, wherein updating the account can include updating the total payment amount to include the most recently charged access price. Responsive to charging the access price of the digital item to the account of the consumer, the tracker component 132 can output a signal that indicates that access to the digital item is authorized to the consumer that is employing the client computing device (e.g., the tablet computing device 104).

When, however, the total payment for the digital item has reached the purchase price of the digital item, the tracker component 132 outputs the signal that indicates that access to the digital item is authorized to the consumer without charging the access price to the account of the consumer. Thus, when the consumer has paid, in the aggregate, the purchase price of the digital item, the consumer can access the digital item (e.g., using any of the client computing devices 102-108) without her account being further charged. The consumer, then, has purchased the digital item by way of the aggregate of access prices charged to the account of the consumer for the digital item over time (and potentially across the client computing devices 102-108). It can be ascertained that the server 110 is configured to facilitate sale of digital items to multiple consumers, wherein each consumer may employ different or multiple client computing devices to access the server 110. Thus, the tracker component 132 is configured to track, for each consumer (and over time), accesses to respective digital items in the plurality of digital items 116. The tracker component 132 is further configured to maintain total payment amounts for each consumer and digital item.

The server 110 can further include an accessor component 134 that receives the signal output by the tracker component 132 and allows the consumer to access the digital item responsive to receipt of such signal. For instance, the accessor component 134 can cause the digital item to be streamed to the client computing device being employed by the consumer to access the server 110. For example, the digital item may be a music or video file, and the accessor component 134 can stream the music or video file to the client computing device that initiated the request for the digital item. In another example, the accessor component 134 can transmit a key (or other security data) that allows the digital item to be accessed at the client computing device. More specifically, a first time that the consumer requests the digital item (through use of one of the client computing devices 102-108), the accessor component 134 can cause the selected digital item to be downloaded to the client computing device together with digital rights management (DRM) data, wherein the DRM data prevents the digital item from being accessed at the client computing device unless a key is received from the server 110. Therefore, the accessor component 134 can be configured to transmit the key to the client computing device, thereby enabling the consumer to access the digital item at the client computing device responsive to the tracker component 132 charging the account of the consumer for the access to the digital item (or determining that the consumer has paid the purchase price for the digital item).

Additionally, as indicated above, the server 110 may optionally include an ad selector component 136 that can select an advertisement from the ads 124 to present the consumer when the client computing device is provided access to the digital item. As noted above, the purchase price and/or the access price for the digital item may be reduced or eliminated when the consumer allows advertisements to be presented thereto when accessing the digital item. Thus, when the consumer indicates a desire to receive advertisements, the ad selector component 136 can select an advertisement from the ads 124 that is believed to be pertinent to the interests of the consumer. Furthermore, as will be described in greater detail herein, the ad selector component 136 may be included in a budget manager component that is configured to manage a predefined budget for the consumer. In such a case, the ad selector component 136 can select one or more advertisements from the ads 124 based upon the budget set by the consumer, the access price of the digital item, the purchase price of the digital item, historic consumer actions, etc.

To exemplify aspects of the framework 100, several examples are provided herein. It is to be understood that these examples are not intended to be limiting, but are instead set forth for purposes of explanation. In an example, the digital items 116 may be music files, each of which has a respective purchase price and a respective access price assigned thereto. As noted above, such prices can be defined by respective owners of the digital items 116. The consumer may be employing the mobile telephone 102, and may request that a particular song be played at the mobile telephone 102 (through interaction with a graphical user interface, which is based upon display data output by the display component 126). Responsive to receiving the request, the server 110 (e.g., the tracker component 132) can determine whether or not the consumer has already paid the purchase price for the song. In other words, the tracker component 132 can determine whether, over time, the account of the consumer has been charged the access price a sufficient number of times, such that the purchase price for the song has been paid by the consumer. When the purchase price has already been paid by the consumer, the server 110 allows access to the song (e.g. streams the song to the mobile telephone 102, allows for the song to be downloaded to the mobile telephone 102, etc.). When the purchase price for the song has not been paid by the consumer, the tracker component 132 charges the access price to the account of the consumer, and updates the total payment amount for the song and the consumer to reflect the charging of the access price to the account. Responsive to the account of the consumer being charged for the song, the accessor component 134 allows the consumer to access the song through use of the mobile telephone 102.

In another example, the consumer may be using the laptop computing device 106, and may request access to a word processing application. In such an example, the account of the consumer may be charged based upon an amount of time that the consumer employs the application at the laptop computing device 106 (or other computing devices of the consumer). Responsive to receiving the request to access the word processing application, the tracker component 132 can determine whether the consumer has already paid the purchase price of the application or the purchase price for a subscription to the application (e.g., whether the consumer has employed the application for a sufficient amount of time, such that the consumer has been charged the purchase price for the application or the subscription to the application). When the consumer has already been charged the purchase price, the tracker component 132 fails to charge the account of the consumer, and the accessor component 134, for example, can transmit a data packet to the laptop computing device 106 that allows the consumer to execute the word processing application thereon without additional charge to the account of the consumer. When, however, the purchase price for the word processing application has not been paid by the consumer (the total payment amount is less than the purchase price), the tracker component 132 can charge the access price to the account of the consumer and can initiate (or restart) a timer. Based upon the access price, then, the consumer can use the word processing application for some predefined unit of time without being further charged. When the amount of time that the consumer uses the application exceeds the predefined unit of time, the tracker component 132 can again charge the access price to the account of the consumer, which restarts the timer—thus, the consumer can continue to use the application for the predefined unit of time (e.g., another five minutes) without her account being further charged. This process can repeat until the aggregate of access prices charged to the account of the consumer reaches the purchase price, after which the account of the consumer is not further charged when the word processing application is executed on a computing device of the consumer.

While the framework 100 has been described above with a relatively simple pricing approach, it is to be understood that other pricing approaches are contemplated. For example, for a digital item in the digital items 116, a first purchase price and a second purchase price may be defined. The first purchase price may be less than the second purchase price, and may be the purchase price charged to the account of the consumer when the consumer wishes to pay the full purchase price up front (e.g., without “testing” the digital item by paying the per-access access price). The second purchase price is higher than the first purchase price, but effectively allows the consumer to “test” the digital item without requiring full up-front payment. For example, the access price for the digital item may be less than both the first purchase price and the second purchase price. In yet another example, the purchase price for a digital item may change as the account of the consumer continues to be charged access prices. For example, initially, the purchase price for a digital item may be $1.00. Accordingly, prior to paying an access price, the consumer may choose to purchase the digital item for $1.00. When the consumer chooses to access the digital item without paying the full purchase price up-front, the consumer may be charged $0.05 for such access. The purchase price, however, may increase to $1.01. Thus, the consumer may, after her account has been charged the access price for the first time, allow her account to be charged an additional $0.96 to purchase the digital item. When the consumer chooses to again pay the access price for accessing the digital item, the purchase price may increase to $1.02. In an example, this can continue until the purchase price reaches a threshold (e.g., $1.10).

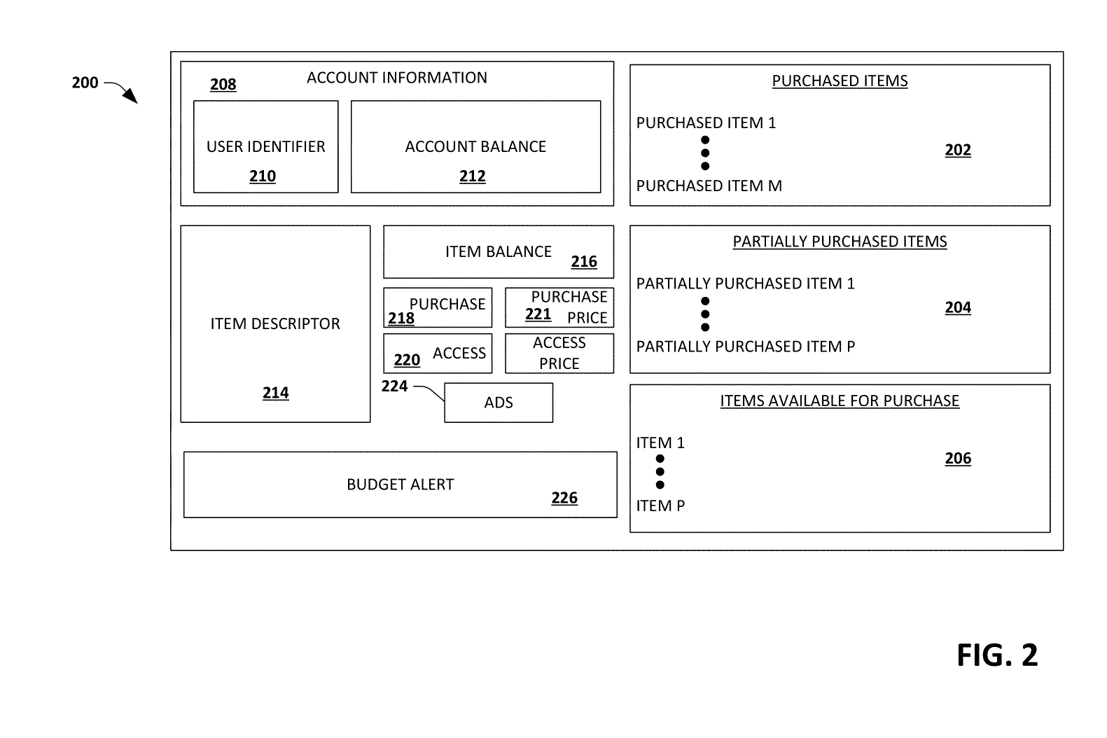

Now referring to FIG. 2, an exemplary graphical user interface (GUI) 200 that may be presented on a client computing device is illustrated. In an exemplary embodiment, the GUI 200 includes a first field 202 that identifies digital items that have been previously purchased by a consumer that is using the client computing device. For instance, when the digital items are music files, the first field 202 can identify songs, albums, etc., that have already been purchased by the consumer. The GUI 200 may also include a second field 204 that identifies digital items that have been partially purchased by the consumer. In other words, the second field 204 identifies digital items for which respective access prices have been charged to the account of the consumer. The GUI 200 may further include a third field 206 that identifies digital items that have not been purchased or accessed by the consumer, but are available for purchase.

The GUI 200 may also include a fourth field 208 that identifies the consumer and account data associated therewith. For example, the fourth field 208 can include a user identifier 210, which may be an image, text, a combination thereof, an animated video, etc., wherein the user identifier 210 identifies the consumer. The fourth field 208 may further include account data 212, which can, for example, identify an account balance, one or more credit cards associated with the account of the consumer, etc.

Pursuant to an example, the consumer can select one of the items shown in the fields 202, 204 or 206. Responsive to selecting such item, an item descriptor 214 can be presented in the GUI 200, where the item descriptor 214 can identify the selected digital item, including a name of the digital item, an image or other identifier for the digital item, etc. An item balance 216 can be presented in the GUI 200, where the item balance 216 identifies a remaining amount, if any, that the consumer is to pay to outright purchase the selected digital item. The GUI may include a first selectable button 218, that when selected by the consumer, causes the item balance identified in the item balance 216 to be charged to the account of the consumer. A purchase price 221 can identify a purchase price for the digital item. A second button 220, when selected by the consumer, can allow for the selected digital item to be accessed for an access price 222.

A third button 224 can be configured to allow an advertisement to be presented in connection with the item identified by the item descriptor 214. Presentation of the advertisement may allow the consumer to access the digital item for a reduced charge or for free. A budget alert field 226 may also be presented in the GUI 200, where the budget alert field 226 can include an alert that informs the consumer that a predefined budget has been in some way impacted or will be impacted by purchase or access of the item represented by the item descriptor 214. For example, the budget alert 226 can inform the consumer that if the consumer purchases the item represented by the item descriptor 214, the budget set by the consumer will be exceeded.

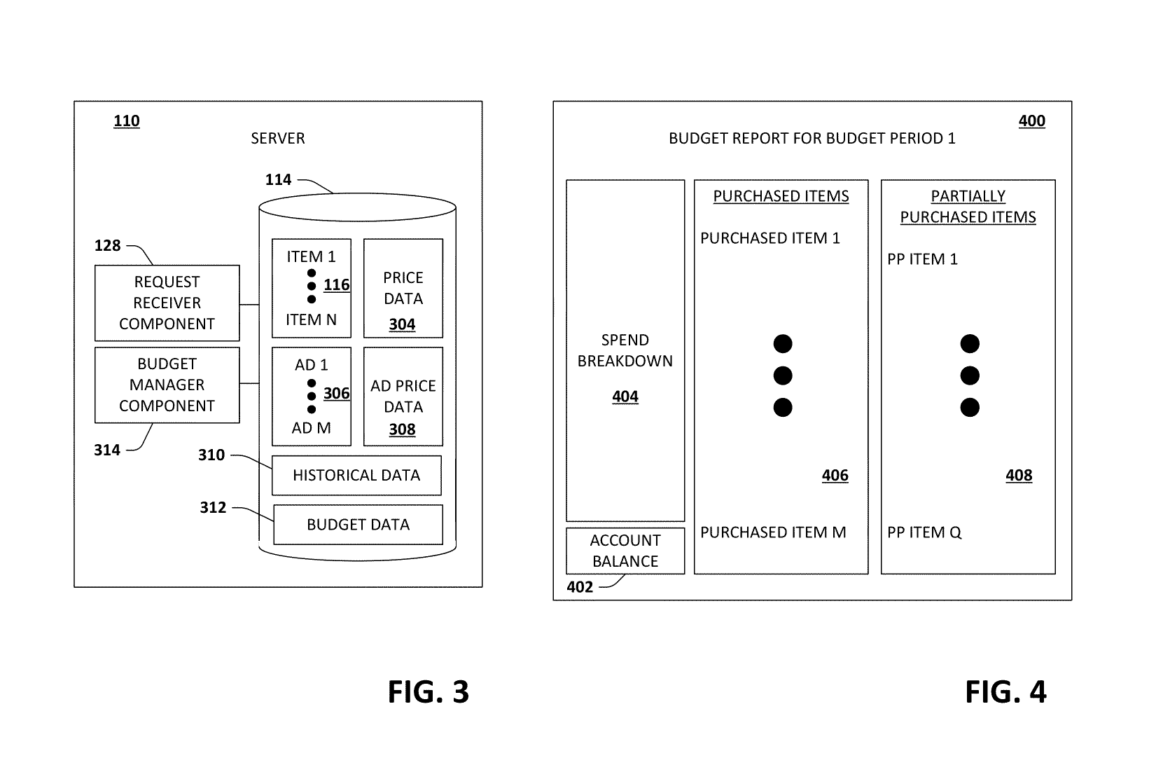

Turning now to FIG. 3, another exemplary depiction of the server 110 is set forth. The server includes the data store 114, wherein the data store 114 includes the plurality of items 116, as well as price data 304 that respectively corresponds to the plurality of items 116. The price data 304 can include purchase prices for the respective items 116 and access prices for the respective items 116.

The data store 114 may also include a plurality of advertisements 306 that may be presented to the consumer on a client computing device used by the consumer to communicate with the server 110. The advertisements 306 can include audio advertisements (e.g., when the digital items 116 are music files), video advertisements (e.g., when the digital items 116 are video files, computer-executable applications, etc.), web based advertisements, etc. The data store 114 may also include ad price data 308 that indicates respective prices associated with the advertisements 306. For instance, an advertiser may desirably present the first advertisement for a first price (e.g., the advertiser is willing to pay a first price to present the first advertisement to the consumer). It can, therefore, be ascertained that a purchase price or access price for a digital item in the digital items 116 may be at least partially offset by an advertisement price set forth in the ad price data 308 for an advertisement in the plurality of advertisements 306.

The data store 114 may also include historical data 310 that indicates historic accesses and/or purchases of digital items by the consumer. The historical data 310 can be analyzed to identify purchasing trends by the consumers or consumers with similar purchasing habits as the consumer. For instance, the historical data 310 can indicate that the consumer spent “X” dollars over the last month on the purchase of digital items that are purchasable by way of the server 110.

The data store 114 may also comprise budget data 312, which can set forth budget parameters for the consumer. In an example, the consumer can indicate a budget of “Y” dollars per month that can be spent on the purchase and/or access of digital items that are purchasable by way of the server 110. Furthermore, the budget data 312 can include preferences defined by the consumer with respect to the purchase and/or access of digital items. For instance, the consumer can indicate a willingness to be provided with ads for a first type (or genre) of digital item, while not being willing to be provided with ads in for a second type (or genre) of digital item. In another example, the budget data 312 can include an indication of a type of ad that is acceptable to be provided to the consumer (e.g., audio, banner, etc.).

The server 110 can include a budget manager component 314 that can manage the budget of the consumer as the consumer requests to purchase and/or access digital items in the digital items 116. Pursuant to an example, the budget manager component 314 can receive the budget data 312, the historical data 310, the ad price data 308, and the price data 304 corresponding to the digital items 116, and can generate a plan for selectively providing advertisements to the consumer when the consumer requests to access a digital item in the plurality of digital items 116.

The request receiver component 128 may receive a request from a client computing device being employed by the consumer to access a digital item in the plurality of digital items 116. The request receiver component 128 can forward such request to the budget manager component 314. The budget manager component 314 can review the budget data 312, the historical data 310, and the price data 304 corresponding to the requested digital item, and can determine whether there is a sufficient balance in the budget data 312 to allow the account of the consumer to be charged such that the consumer can access the digital item (e.g. the budget manager component 314 can determine whether accessing the digital item will eventually cause the budget of the consumer to be exceeded). When the budget manager 314 determines that the consumer budget will not be exceeded, the budget manager component 314 can output a signal that indicates that the requested digital item can be accessed by the consumer without being supported by an advertisement. When, however, the historical data 310 indicates that accessing the digital item may eventually cause the budget of the consumer to be exceeded, then the budget manager component 314 can analyze the budget data 312, the advertisements 306, and the ad price data 308 to select an advertisement to support the accessing of the digital item. Accordingly, the budget manager component 314 provides some intelligence as to when to set forth advertisements to the consumer in connection with ensuring that the budget of the consumer set forth in the budget data 312 is not exceeded.

With reference now to FIG. 4, an exemplary budget report that can be set forth to the consumer on a display screen of a client computing device is illustrated. The budget report 400 can include an account balance 402 that can indicate, for instance, an amount in the account of the consumer remaining in a budget for a specified time period. The budget report 400 may also include a spend breakdown field 404 that includes information describing how units of value in the account were spent over a particular budget. For example, the spend breakdown field 404 can indicate an amount of money that was spent for a particular type of digital item over a budget period, a genre of digital items accessed over the budget period, time periods when digital items were purchased, etc. The budget report 400 can also include a field 406 that identifies digital items that were purchased during the budget period, as well as a field 408 that identifies digital items that were partially purchased during the budget period (e.g., where the access price was paid but the purchase price has not yet been met).

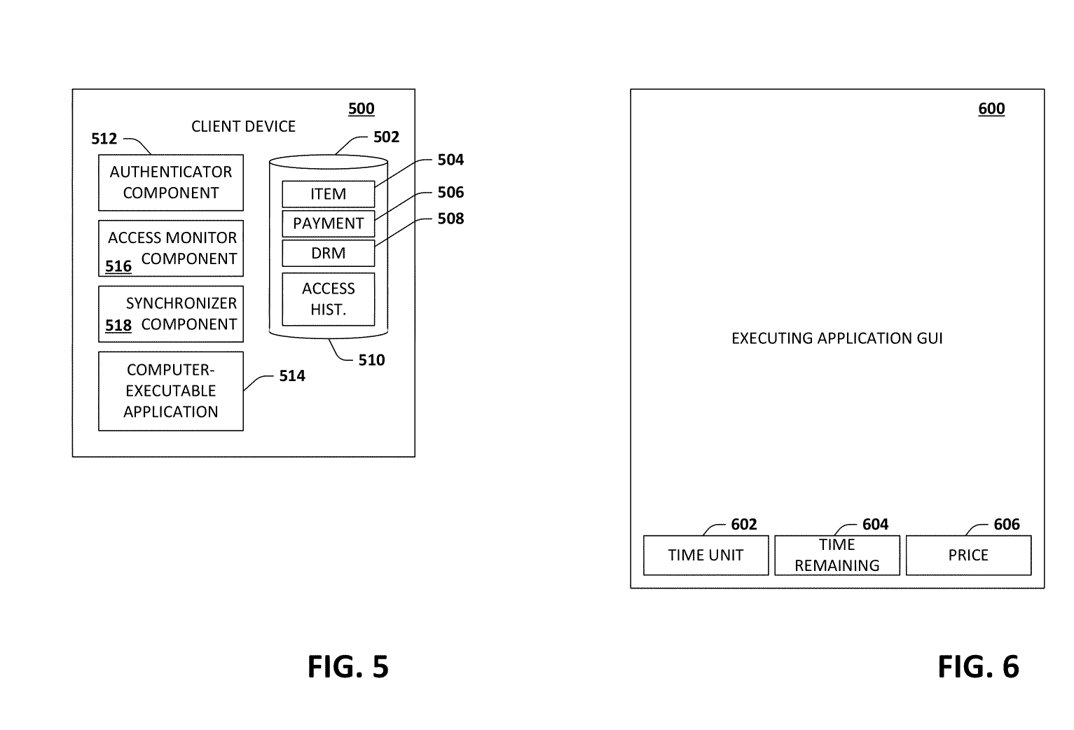

Referring now to FIG. 5, an exemplary depiction of a client computing device 500 that can be used by the consumer to access and/or purchase digital items is illustrated. In the exemplary client device 500, the consumer may desirably access downloaded digital items when the client device 500 is unable to connect to the server 110 (e.g., wherein the client device 500 is offline). The client device 500 includes a data store 502, where the data store 502 comprises a digital item 504 that has been has been downloaded to the client device 500 from the server 110. The data store 502 may also include payment information 506 pertaining to the item 504, where the payment information 506 can indicate the total payment amount (e.g., the amount already paid by the consumer for the item 504). The item 504 may also have DRM data 508 associated therewith, that may, in some circumstances, prevent the item 504 from being accessed or otherwise limit the access that can be made to the item 504. For instance, the DRM data 508 can restrict access the consumer, can restrict access to a particular number of accesses, etc. The data store 502 also includes access history 510, which indicates a number of times that the item 504 has been accessed since the client device 500 has been synchronized with the server 110.

The client device 500 may include an authenticator component 512 that receives identification data from the consumer and authenticates such identification data. The identification data may be a username and password, biometric data, etc. The DRM data 508 may prevent the digital item 504 from being accessed at the client device 500 unless the authenticator component 512 can authenticate the identification data set forth by the consumer.

The client device 500 further includes a computer executable application 514 that is configured to allow the consumer to access the item 504. The computer-executable application 514 may be a web browser, an application for playing music files, an application for playing video files, a word processing application, a spreadsheet application, a video game, etc. An access monitor component 516 monitors accesses to the digital item 504 made by the consumer by way of the computer-executable application 514. For instance, when the consumer causes the computer-executable application 514 to execute on the client device 500 and uses the computer-executable application 514 to select the digital item 504, the access monitor component 516 can monitor such access and update the access history 510 to indicate that the consumer has accessed the digital item 504 when the client device 500 is not in communication with the server 110.

The client device 500 further includes a synchronizer component 518 that, when the client device 500 couples to the server 110, transmits the access history 510 to the server 110, such that the account of the consumer is charged for the accesses to the digital item 504 when the client device 500 was offline. In an example, the DRM data 508 can prevent access of the digital item 504 to a threshold number of times before requiring that the client device 500 connect to the server 110, and the synchronizer component 518 causes the access history data 510 to be transmitted to the server 110. The server 110 can receive the data provided by the synchronizer component 518 and can charge the account of the consumer the appropriate amount. For instance, if the aggregate of accesses causes access prices for accessing the item 504 on the client device 500 to reach the purchase price for the item 504, then the server 110 can charge the account of the consumer only up to the purchase price, even when the consumer accessed the item 504 many times.

With reference now to FIG. 6, an exemplary graphical user interface 600 of an application executing on the client device 500 is depicted. The GUI 600 can include a GUI native to the executing application. Additionally, using the pricing framework described herein, the GUI 600 can include a graphical item 602 can indicate a defined time unit, wherein when the access price is charged to the account of the consumer for the computer-executable application, the consumer can cause the client device 500 to execute the computer-executable application for the time unit without her account being further charged for accessing the computer-executable application. The GUI 600 may also include a second graphical item 604 that indicates an amount of time remaining until the account of the consumer will again be charged the access price. For instance, the second graphical item 604 can inform the consumer that two minutes of access to the application remain until the access price will again be charged to the account of the consumer. A third graphical item 606 can inform the consumer of the access price for obtaining access to the computer-executable application for the time unit specified in the first graphical item 602 (or purchase price of the application). When the aggregate of access prices reaches the purchase price, the graphical items 602-606 may be removed from the GUI 600.

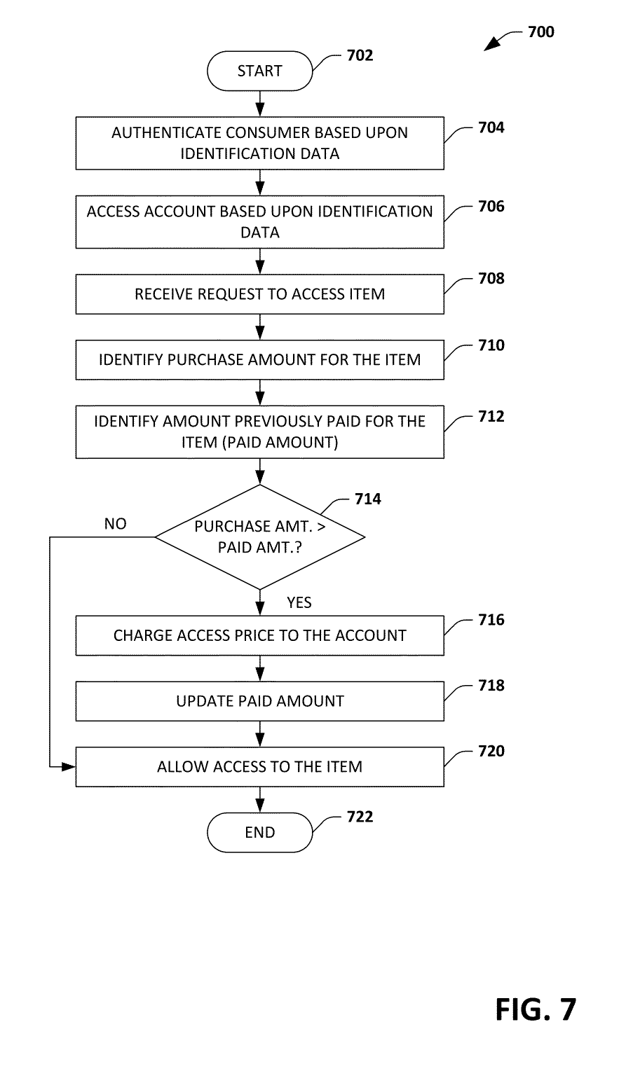

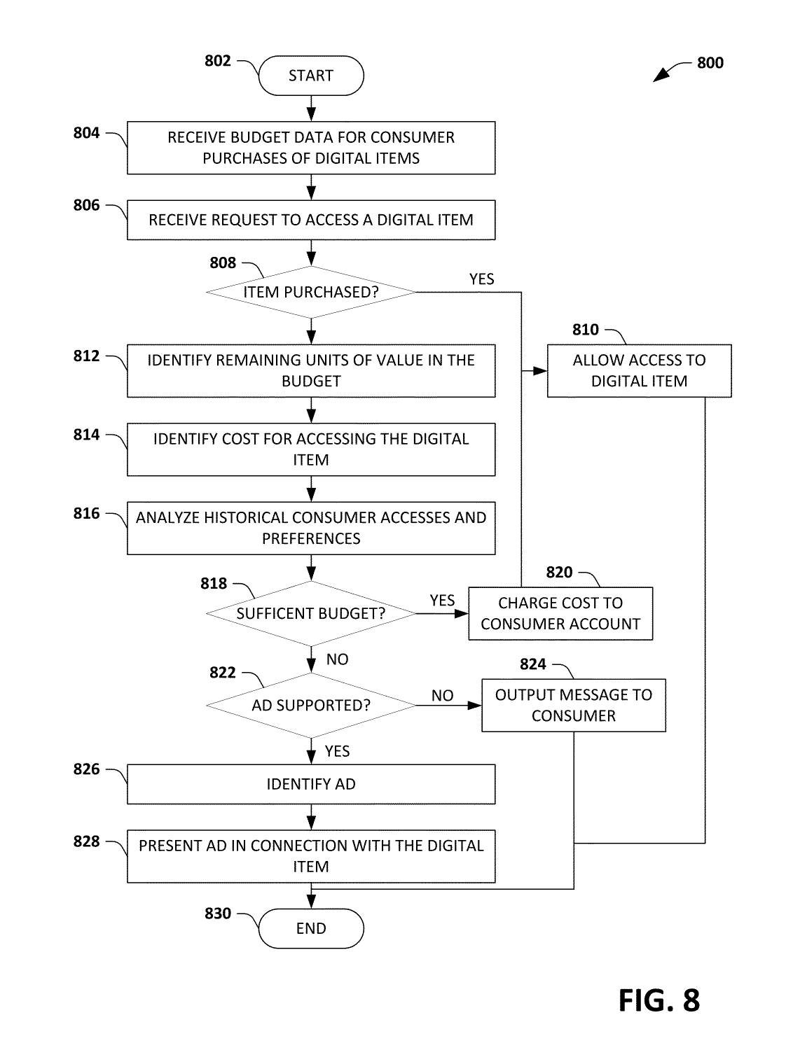

FIGS. 7 and 8 illustrate exemplary methodologies relating to sale of digital items to consumers. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

With reference now to FIG. 7, an exemplary methodology 700 for selling a digital item to a consumer is illustrated. The methodology 700 starts at 702, and at 704, a consumer is authenticated based upon identification data. As noted above, this identification data may be a username and password, biometric data, or the like. At 706, an account of the consumer is accessed based upon the identification data. The account of the consumer may include units a value, such that the account includes credits. In another example, the account of the consumer may be linked to another account that can be charged, such as a debit account, credit card account, etc.

At 708, a request is received to access a digital item that is stored in computer readable storage of a server. The digital item is purchasable for a purchase amount. At 710, the purchase amount for the item is identified. At 712, an amount previously charged to the account of the consumer for the digital item is identified. For example, the account of the consumer may be charged an access price each time the consumer accesses the digital file. The access prices charged to the account of the consumer for the digital item can be aggregated, wherein the aggregate of the access prices is the paid amount for the digital item.

At 714, a comparison is undertaken to determine whether the purchase amount for the digital item is greater than the paid amount for the digital item. When the purchase amount is greater than the paid amount (e.g., the aggregate of access prices charged to the account of the consumer for the digital item does not reach the purchase price for the digital item), then the methodology 700 proceeds to 716, where the access price is charged to the account of the consumer. At 718, the paid amount is updated to reflect the charging of the access price to the account of the consumer (e.g., the paid amount is updated to equal the previously stored paid amount plus the access price). At 720, the consumer is allowed access to the digital item. For example, the digital item may be streamed to a client computing device being used by the consumer, a key that allows the client computing device to access the digital item can be transmitted to the client computing device, etc. When, at 714, it is determined that the purchase amount is not greater than the paid amount (e.g., over time the consumer has paid the access price a sufficient number of times such that the purchase price has been paid), then the methodology 700 proceeds to 720, where access to the digital item is allowed. The methodology 700 completes at 722.

Now referring to FIG. 8, an exemplary methodology 800 for managing a consumer budget for accessing and/or purchasing digital items is illustrated. The methodology 800 starts at 802, and at 804, budget data for consumer purchases of digital items is received. The budget data, as indicated above, can identify a maximum amount of money that the consumer is willing to spend on digital items over a budget period. The budget data may also include preference data, including indications of a type of digital item that is desirably ad supported, times during the day when ad supported access to digital items is acceptable to the consumer, etc. At 806, a request to access a digital item is received from a client computing device of the consumer.

At 808, a determination is made regarding whether the digital item has already been purchased by the consumer. When it is determined at 808 that the digital item has already been purchased by the consumer, the methodology 800 proceeds to 810, where access is allowed to the digital item. Since the digital item has already been purchased, no further charge will be made against the account of the consumer for the digital item, and thus the budget is unaffected. If at 808 it is determined that the item has not already been purchased by the consumer, then at 812 a number of units of value remaining in the budget for the current budget period is identified. At 814, the access price (cost) for accessing the digital item is identified. At 816, historical consumer accesses and preferences specified in the budget data is analyzed.

At 818, a determination is made regarding whether there exists sufficient units of value in the budget to allow for the access price to the digital item to be paid without potentially causing the budget to be exceeded. For instance, if there is a relatively short amount of time remaining in the budget period and a relatively large number of units of value remaining in the budget, and a trend in the historical data indicates that the consumer will not request a large number of digital items in the near future, then it can be determined that sufficient units of value exist in the budget to allow for the digital item to be accessed, and the account of the consumer can be charged the access price for the digital item. When it is determined, at 818, that there is a sufficient number of units of value in the budget for the budget period, then at 820, the account of the consumer is charged the access price, and the methodology 800 proceeds to 810, where access to the digital items allowed.

When, however, it is determined that there is an insufficient number of units of value in the budget to allow for the access price to be charged to the account of the consumer (without fear of exceeding the budget for the budget period), then a determination is made at 822 as to whether the digital item selected by the consumer can be supported by at least one advertisement. If it is determined that the selected digital item is not ad-supported, then at 824 a message or warning is output to the consumer that informs the consumer that the budget for the current budget period may be exceeded due to the request to access the digital item. The consumer may choose to ignore such message and cause the digital item to be accessed; however, nevertheless the consumer has been informed of the possibility of exceeding the budget. When at 822 it is determined that the digital item is ad-supported, then the methodology 800 proceeds to 826, where an advertisement that can be presented to the consumer in connection with the selected digital item is identified. Such advertisement can be identified based at least in part upon an advertisement price associated therewith, wherein an advertiser is willing to offset at least a portion of the access price of the digital item to present the consumer with the advertisement. At 828, the advertisement is presented in connection with the selected digital item, and the methodology 800 ends at 830.

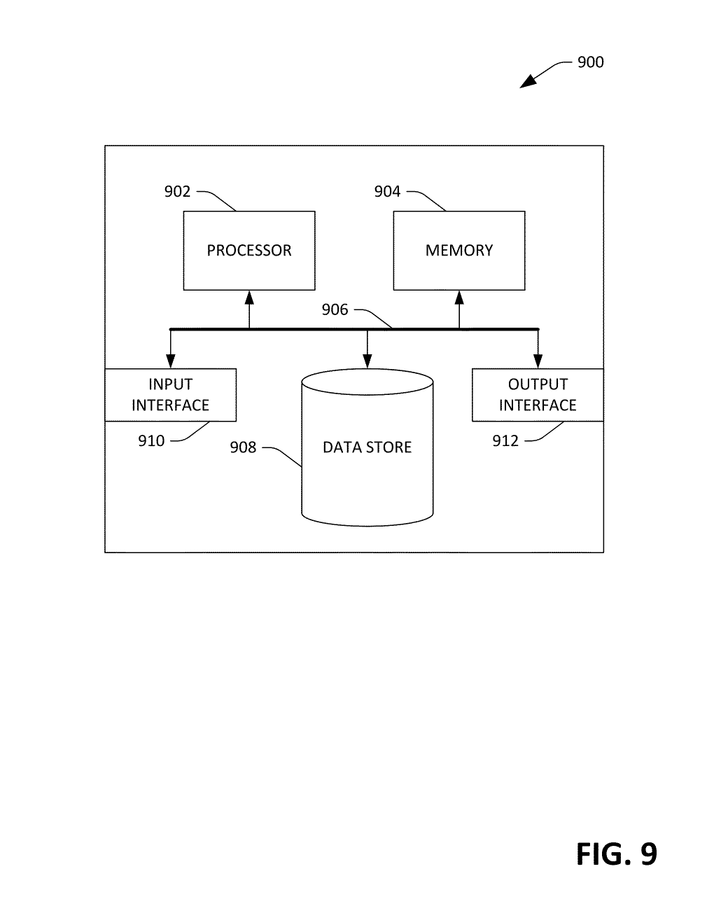

Referring now to FIG. 9, a high-level illustration of an exemplary computing device 900 that can be used in accordance with the systems and methodologies disclosed herein is illustrated. For instance, the computing device 900 may be used in a system that supports selling digital items. By way of another example, the computing device 900 can be used in a system that supports managing a budget of a consumer, the budget set forth for purchasing digital items. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store digital items, price information for the digital items (access prices and purchase prices), advertisements, etc.

The computing device 900 additionally includes a data store 908 that is accessible by the processor 902 by way of the system bus 906. The data store 908 may include executable instructions, digital items, advertisements, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 900 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for instance, several devices may be in communication by way of a network connection and may collectively perform tasks described as being performed by the computing device 900.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method executed by a processor of a computing device, the method comprising:
receiving identification data that identifies a consumer;
accessing an account of the consumer that corresponds to the identification data, the account associated with units of value;
receiving a request to access a digital item that is stored in computer-readable storage, the digital item being purchaseable for a purchase price and accessible for an access price, the access price being less than the purchase price;
identifying a paid amount, the paid amount being an aggregate of access prices previously charged to the account for the digital item;
comparing the paid amount with the purchase price;
when the paid amount is less than the purchase price:
charging the access price to the account of the consumer;
updating the paid amount to reflect credit of the access price towards the purchase price;
responsive to charging the access price to the account of the consumer, allowing access to the digital item; and
when the paid amount is equal to the purchase price, allowing access to the file without charging the access price to the account.

2. The method of claim 1, wherein the digital item is a media file, and wherein allowing access to the media file comprises causing the media file to be played.

3. The method of claim 2, the computing device comprising the computer-readable storage, the media file comprising digital rights management (DRM) data that prevents the media file from being played at the computing device unless:
the account has been charged the access price; or
the paid amount is equal to the purchase price.

4. The method of claim 3, the DRM data further prevents the media file from being played at the computing device prior to the identification data being received.

5. The method of claim 2, wherein the access price is for a single play of the media file, the media file unable to be subsequently played unless:
the access price is again charged to the account; or
the paid amount is equal to the purchase price.

6. The method of claim 1, wherein the file represents a computer-executable application, the access price is based upon a unit of time, the application being accessible for the unit of time without an additional charge being made to the account.

7. The method of claim 6, further comprising:
monitoring an amount of time that the computer-executable application is accessed;
comparing the amount of time with the unit of time;
determining that the computer-executable application has been accessed for the unit of time; and
responsive to determining that the computer-executable application has been accessed for the unit of time, again charging the account the access price, wherein again charging the account the access price allows for continued access to the computer-executable application for the unit of time.

8. The method of claim 7, further comprising:
tracking, for a plurality of discrete accesses to the computer-executable application, respective amounts of time of the discrete accesses; and
aggregating the respective amounts of time of the discrete accesses to generate the amount of time that the computer-executable application is accessed.

9. The method of claim 1, further comprising:
receiving an indication that at least one advertisement is to be presented in connection with the digital item being accessed; and
setting a value for the access price based upon the indication that the at least one advertisement is to be presented in connection with the digital item being accessed.

10. The method of claim 1, further comprising:
receiving a budget, the budget identifying a maximum amount that is to be charged to the account for digital items over a defined period of time; and
responsive to receiving the request to access the digital item, presenting an advertisement in connection with the digital item, the access price based upon the advertisement being presented in connection with the digital item, the advertisement presented based upon the access price and the budget.

11. The method of claim 1, the file being a computer-executable application, the method further comprising:
transmitting timer data for display on a display screen, the timer data overlaying a graphical user interface of the computer-executable application, the timer data indicating an amount of time that the computer-executable application is able to be executed without the account being charged the access price.

12. A system, comprising:
a processor; and
a memory that comprises a plurality of components that are executed by the processor, the plurality of components comprising:
a display component that causes a purchaseable digital item to be displayed on a display screen, the purchaseable digital item being purchaseable for a purchase price from an account;
a request receiver component that receives a request to access the digital item, the digital item accessible for an access price from the account, the access price being less than the purchase price;
a tracker component that, responsive to the request receiver component receiving the request to access the digital item, is configured to:
compare a total payment for the digital item with the purchase price of the digital item, the total payment being an aggregate of historic charges from the account for the digital item;
when the total payment for the digital item is less than the purchase price of the digital item:
charge the access price to the account;
update the total payment for the digital item to reflect the charging of the access price to the account; and
output a signal that indicates that access to the digital item is authorized; and
when the total payment for the digital item is equal to the purchase price of the digital item, output the signal that indicates that access to the digital item is authorized without charging the access price to the account; and
an accessor component that receives the signal and allows access to the digital item responsive to receipt of the signal.

13. The system of claim 12 comprised by a server that is accessible to a client computing device by way of a network, the request to access the digital item received from the client computing device, wherein the accessor component allows access to the digital item by transmitting a data packet to the client computing device.

14. The system of claim 13, further comprising an authenticator component that receives identification data from the client computing device, the authenticator component identifies the account based upon the identification data.

15. The system of claim 14, the tracker component configured to track accesses to the digital item from a plurality of different computing devices, wherein the total payment is based upon the accesses to the digital item from the plurality of different computing devices.

16. The system of claim 13, wherein the display component is configured to cause the purchase price of the digital item and the total payment for the digital item to be displayed on the display screen together with the digital item.

17. The system of claim 13, wherein the digital item is a music file, the tracker component charges the access price to the account for each play of the music file at the client computing device until the total payment equals the purchase price.

18. The system of claim 17, wherein the accessor component streams the music file to the client computing device responsive to receiving the signal.

19. The system of claim 13, wherein the digital item is a video game, the tracker component configured to charge the access price to the account when an amount of time that the video game is played at the client computing device exceeds a threshold time.

20. A computer-readable storage medium comprising instructions that, when executed by a processor, causes the processor to perform acts comprising:
receiving a first request from a first client computing device to play a music file at the client computing device, the music file purchaseable for a purchase price, the purchase price being a plurality of units of value;
receiving first data that identifies an account from the first client computing device;
responsive to receiving the first request, charging an access price to the account, the access price being at least one unit of value, the access price being less than the purchase price;
responsive to charging the access price to the account, streaming the music file to the first client computing device;
subsequent to streaming the music file to the first client computing device, receiving a second request to access the music file from a second client computing device;
receiving second data that identifies the account from the second client computing device;
responsive to receiving the second request, again charging the access price to the account;
responsive to again charging the access price to the account, streaming the music file to the second client computing device; and
for any request from a client computing device that is associated with the account that is received subsequent to the access price being again charged to the account, streaming the music file to the client computing device without charging the account.
